(19) United States
(12) Patent Application Publication
(10) Pub. No.: US 2010/0219302 A1
(43) Pub. Date: Sep. 2, 2010

(54) Portable Gun and Crossbow Holder

(76) Inventor: David A. Krasnicki, Allenton, MI (US)

Correspondence Address: GREGORY T. ZALECKI, 12900 HALL ROAD, SUITE 400, STERLING HEIGHTS, MI, 48313, US

(21) Appl. No.: 12/779,700

(22) Filed: May 13, 2010

Related U.S. Application Data
(63) Continuation-in-part of application No. 11/308,295, filed on Mar. 15, 2006.
Application No. 11/308,295 is a continuation-in-part of application No. 12/370,354, filed on Feb. 12, 2009.

(51) Int. Cl. F16M 11/04

(52) U.S. Cl. 248/121

(57) ABSTRACT

A portable gun and crossbow holder is intended to be used to support a gun or a crossbow such that the gun or crossbow may be quickly and easily retrieved. The device is comprised of a body, an attachment member, a pair of removable brackets and a pair of straps. The body consists of two hingedly connected branches allowing the body to be folded and unfolded. The attachment member projects downwardly from a central section of the body and attaches to a support structure. The removable brackets attach to the branches. The distance between the removable brackets is adjustable. Each strap is attached to a bracket to form a sling aligned with the body. The depth of the sling is adjustable. The separated components of the gun and crossbow holder and the folded body are reduced in size and volume compared to the assembled gun and crossbow holder.

### CROSS-REFERENCE TO RELATED APPLICATIONS

This is a continuation-in-part of U.S. patent application Ser. No. 11/308,295 filed on Mar. 15, 2006, now pending and of U.S. patent application Ser. No. 12/370,354 filed on Feb. 12, 2009, now pending. application Ser. No. 11/308,295 and application Ser. No. 12/370,354 are incorporated herein by reference.

### BACKGROUND

Gun and crossbow owners use their guns and crossbows for hunting, target shooting or both. It is desirable to avoid laying a gun or a crossbow on the ground. The ground may be muddy, wet or covered with snow. If the gun or crossbow is laying on the ground it can easily be contaminated by mud, water or snow. It also takes much more time to retrieve a gun or crossbow laying on the ground and to shoot at a hunted animal as compared to shooting at a hunted animal while the gun or crossbow is already being grasped by the hunter.

The solution of having the user continuously holding the gun or crossbow is also not desirable. After a short period of time continuously holding the gun or crossbow becomes tiring and boring. Similarly, the solution of temporarily storing the gun or crossbow within a storage case is not desirable. Loading and unloading the gun or crossbow into the storage case is needlessly time-consuming. The case can become muddied, wet, or contaminated by snow or other debris. When the gun or crossbow is stored within a storage case there will usually be insufficient time for a hunter to retrieve the gun or crossbow after a hunted animal is spotted.

Hunters often hunt from within trees. It is impractical to store a gun or crossbow in a storage case while the hunter is in a tree. Likewise, it is impractical for a hunter positioned within a tree to store the gun or crossbow on any part of the tree structure. Trees do not normally provide surfaces for securely retaining guns or crossbows. Even if such a surface could be found within a tree, the delay caused by the procedure required to retrieve the gun or crossbow and shoot while hunting would often be unacceptable.

There is a need for an improved portable gun and crossbow holder having the following characteristics. It could be mounted on the ground or upon a tree limb. It would hold and keep a gun or crossbow elevated above the ground or a tree limb upon which it is mounted. Its height would be adjustable so that a user could use the portable gun and crossbow holder while sitting, standing or squatting. It would be easy to store. It would be lightweight and take up minimal space. It could be quickly assembled. Optionally, in the case of a crossbow holder, it would provide a quiver for holding arrows or bolts.

### SUMMARY

The improved portable gun and crossbow holder described herein has these desirable characteristics. The portable gun and crossbow holder may be attached to a base fixed within the ground. It may be attached to a tree mount or a mount attached to the floor of a treestand or the floor of a hunting blind. Or, it may be attached to one or more extension members wherein a bottom extension member is attached to a base or a tree mount.

A portable gun and crossbow holder is comprised of a body, an attachment member, a pair of removable brackets and a strap for each bracket. The body is comprised of two branches. The branches are connected to each other by a hinge such that the body has two configurations. The first configuration is a folded configuration. The second configuration is an unfolded configuration. In the unfolded configuration the branches are linearly aligned and have a longer length. In the folded configuration the branches lie on top of each other and have a shorter length. The folded configuration has a shorter longitudinal length than the unfolded configuration. The folded configuration is used for storing the device. The unfolded configuration is used when the device is operational. Each branch has one or more openings. The branch openings are adapted to receive a removable bracket anchor. A removable anchor is attached to each bracket.

The attachment member downwardly projects from a central section of the body. The attachment member has a first mating end. The mating end of the attachment member is at its distal end. The distal end of the attachment member is that end which is furthest from the body. The first mating end of the attachment member is adapted to be attached to a second mating end. The second mating end is provided by a support structure which supports the portable gun and crossbow holder.

Each bracket has an anchor. The anchor is comprised of at least one lower bracket projecting member. The lower bracket projecting member is adapted to removably and securely fit within an opening of a branch. The anchor may be a U-shaped bracket wherein the legs of the U comprise the projecting members. Each bracket has a pair of upright posts. Each post is adapted to secure a strap between the posts. Each bracket is secured to a branch by a bracket projecting member which extends through an opening within the branch. The brackets may be in the form of a U-shaped rod. A U-shaped anchor may be welded to its corresponding bracket.

One strap is attached to each pair of upright posts. The straps support the gun or crossbow within the portable gun and crossbow holder.

The brackets formed a channel. The channel is longitudinally aligned with the body. The channel provides a recess for receiving a gun or a crossbow.

The straps form a sling within the longitudinally aligned channel. The sling supports a gun or a crossbow within the channel.

The described gun and crossbow holder is intended to be attached to a support structure. Ideally, the support structure is a device which may be inserted into the ground. It has a pointed end for ground insertion. It has pedals for applying a force to insert the pointed end into the ground. The pedals are hingedly attached to the device so that the device will fit into a smaller container when not in use. The support structure is provided with a second mating end. The second mating end of the support structure mates with the first mating end of the gun and crossbow holder. The gun and crossbow holder may be raised with respect to the support structure by inserting one or more extension members between the gun and crossbow holder and the support structure. The gun and crossbow holder may also be directly attached to a tree mount. The tree mount consists of a flange and a second mating end. The flange is securable to a branch of a tree. The second mating end of the tree mount mates with the first mating end of the attachment member of the portable gun and crossbow holder.

The attachment member has a first mating end projecting downwardly from its center area. The first mating end is shaped and sized to mate with a member having a second mating end. Preferably, the first mating end is at the terminal end of a pipe. Preferably, the first mating end of the pipe is the opening at its lower end. The first mating end fits over another structural member. The other structural member may be a pipe projecting from the base, the upper end of an extension member or a pipe projecting from a tree mount. The outside diameter portion of the other structural member in such a configuration fits into the inside diameter opening of the attachment member. Thus the lower end of the attachment member is preferably shaped and sized to receive and securely hold a structural member which is a part of the base, a tree mount or an extension member.

The portable gun and crossbow holder may be attached to a base, a tree mount or an extension member. The base is comprised of a stem and a pair of pedals. The lower end of the stem is pointed to facilitate insertion into a ground surface. The upper end of the stem has a second mating end. As used herein second mating ends mate with first mating ends. The second mating end of the stem is shaped and sized to mate with a member having a first mating end. Thus, if the member having a first mating end is the attachment member of the bow cradle, the second mating end of the stem is shaped and sized to mate with the first mating end of the attachment member. Preferably, the outside diameter portion of the second mating end of the upper end of the stem tightly fits within the inside diameter portion of the first mating end of the attachment member. The pedals are hingedly attached to the upper end of the stem. This allows a user to apply a ground insertion force to the stem with the user's foot. The lower end of the attachment member is attached to the upper end of the stem such that the first mating end of the attachment member on the lower end of the attachment member mates with the second mating end on the upper end of the stem.

The portable gun and crossbow holder may be mounted to a tree mount. A tree mount is comprised of a flange and a mating member. The flange is adapted to be seated upon a tree limb. The flange is also adapted to be seated upon the floor of a tree stand or the floor of a hunting blind. The flange has a plurality of fastener openings for securing the flange upon the tree limb with fasteners. The fasteners may be nails or screws, as well as other types of fasteners. The mating member is perpendicularly attached to the flange. The distal end of the mating member has a second mating end which is sized and shaped to mate with a member having a first mating end. Preferably, the mating member is a pipe having an outside diameter portion which tightly and securely fits within the first mating end of an attachment member. Because the mating member is configured to have a second mating end which is sized and shaped to mate with a member having a first mating end, the mating member may also be attached to the first mating end of an extension member. When the portable gun and crossbow holder is used with a tree mount the lower end of the attachment member is attached to the distal end of the mating member such that the first mating end of the attachment member on the lower end of the attachment member mates with the second mating end on the distal end of the mating member.

When the portable gun and crossbow holder is directly attached to a base or a tree mount a relatively low gun or crossbow holding position is established. The user may desire that the gun or crossbow be positioned higher from the mounting surface, whether that surface be the ground or a tree limb. Higher gun or crossbow holding positions may be obtained by installing one or more extension members between the portable gun and crossbow holder and the base or tree mount. Each extension member has an upper end and a lower end. The upper end of each extension member has a second mating end. The second mating end is shaped and sized to mate with a member having a first mating end. The lower end of each extension member has a first mating end shaped and sized to mate with a member having a second mating end. The member may be another extension member or the upper end of the stem of a base. The lower end of one extension member is attached to the upper end of the stem. The lower end of the attachment member of the portable gun and crossbow holder is attached to a second mating end of an extension member, if an extension member is used. If more than one extension member is used they are connected together at mating ends such that the completed extension member assembly has a second mating end at its upper end and a first mating end at its lower end.

A quiver may be attached to the extension member or extension members. Preferably, the quiver is releasably attached so that its use is optional and so that it may be easily and quickly attached and removed.

### DRAWINGS

These and other features, aspects, and advantages of the present invention will become better understood with regard to the following description, appended claims, and accompanying drawings where:

FIG. 1 is side view of a portable gun and crossbow holder wherein a gun is being supported.

FIG. 2 is a perspective view of the gun and crossbow holder of FIG. 1 with the gun removed and each strap separated from one post.

FIG. 3 is a partial exploded view of the gun and crossbow holder of FIG. 2.

FIG. 4 is a partial enlarged side view of the portable gun and crossbow holder of FIG. 1.

FIG. 5 is a side view of the portable gun and crossbow holder of FIG. 1 wherein the gun has been replaced by a crossbow.

FIG. 6 is a partial perspective view of a base supporting a gun and crossbow holder.

FIG. 7 is an exploded view of a base and two extension members usable to support a portable gun and crossbow holder.

FIG. 8 is a partial perspective view of the attachment member of a portable gun and crossbow holder attached to a tree mount.

### DESCRIPTION

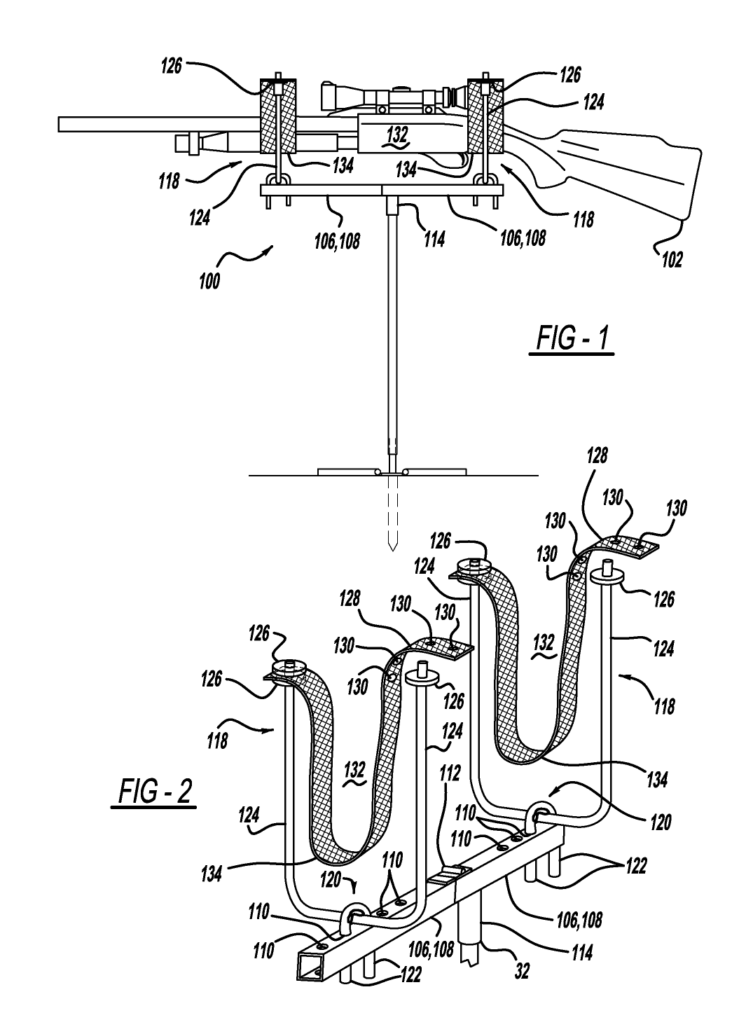

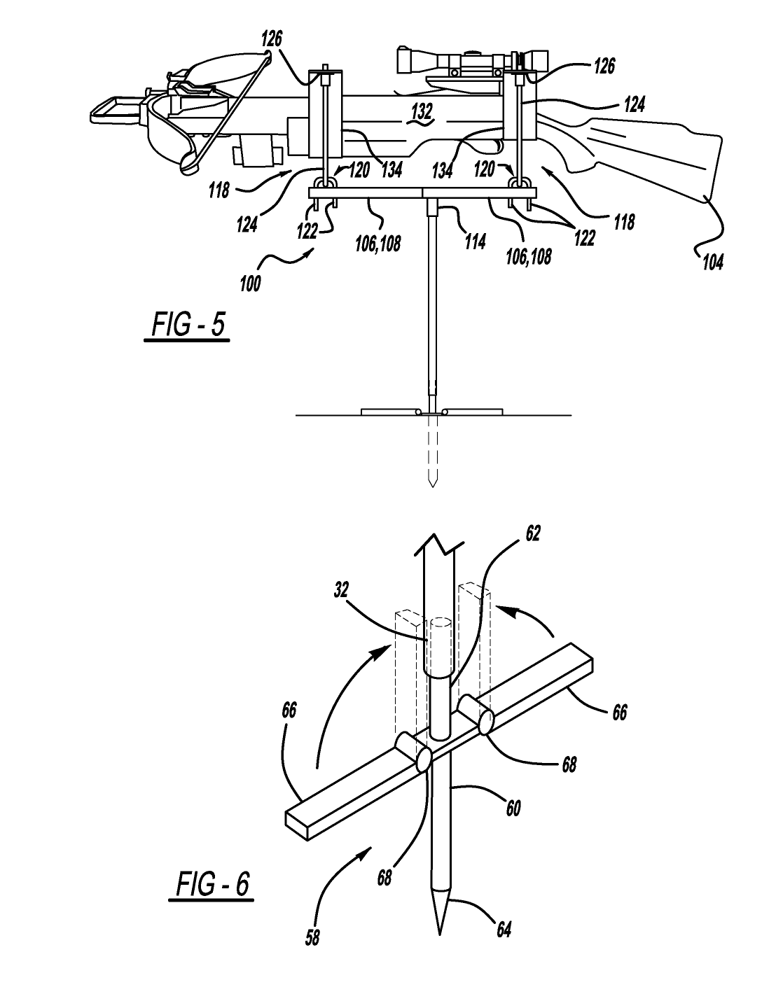

Guns 100 and crossbows 104 are shooting devices. A portable gun and crossbow holder 100 is shown in FIGS. 1-5. The portable gun and crossbow holder 100 is intended to securely hold a gun 100 or a crossbow 104 such that the gun 100 or crossbow 104 is not contaminated by water, mud or other debris on the ground and such that the gun 100 or crossbow 104 may be quickly retrieved for use.

A portable gun and crossbow holder 100 is comprised of a body 106, an attachment member 114, a pair of removable brackets 118 and a strap 128 for each bracket. The body 106 has two branches 108. The branches 108 may be fabricated from square steel tubing. The branches 108 are attached together by a hinge 112, as shown in FIG. 2. The hinge 112 permits the body 106 to have two configurations. The first is an unfolded configuration wherein the branches 108 are linearly aligned. The second is a folded configuration wherein one branch 108 is folded on top of the other branch 108 and wherein the folding occurs at the hinge 112. In the folded configuration the body 106 has about one half the length that the body 106 has in the unfolded configuration. This facilitates easy storage of the body 106 in a small container. Each branch 108 has one or more branch openings 110. The branch openings 110 are adapted to receive a removable bracket anchor 120. The preferred bracket anchor 120 is comprised of two lower projecting members 122. At least one of the branches 108 has a plurality of branch openings 110 which allow a bracket anchor 120 to be removably attached at multiple positions along the branch 108. This allows the removable brackets 118 to have an adjustable position along the body 106.

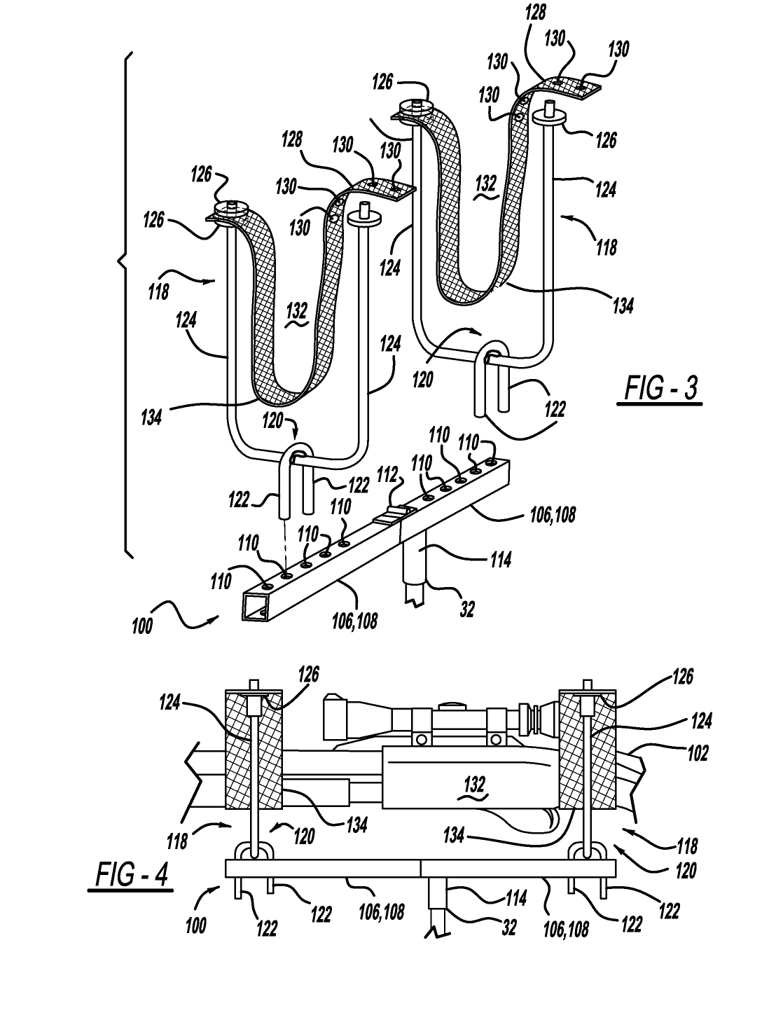

The attachment member 114 projects downwardly from a central section of the body 106, as shown in FIG. 3. The attachment member 114 has a first mating end 32 at its distal end. The distal end is that end the furthest from the interface between the body 106 and the attachment member 114. The purpose of the attachment member 114 is to permit the portable gun and crossbow holder 100 to be attached to a support structure, as described below. The first mating end 32 of the attachment member 114 is intended to be attached to a second mating end. The second mating end provides the attachment interface between the body 106/attachment member 114 and a support structure. This is described in further detail below.

A pair of removable brackets 118 are attachable to the body 106. The removable brackets 118 provide a structure for supporting and positioning a gun 102 or a crossbow 104. Each bracket 118 has an anchor 120. The bracket anchor 120 provides a mechanism for removably and securely attaching the bracket 118 to a branch 108. It is desirable to removably attach the bracket 118 to a branch 108 so that the portable gun and crossbow holder 100 may be taken apart and stored in a small container when not in use. It is desirable to securely attach the bracket 118 to a branch 108 so that any gun 102 or crossbow 104 supported by the portable gun and crossbow holder 100 is stable and secure. The preferred bracket anchor 120 is U-shaped and has two projecting members 122, as shown in FIG. 3. The projecting members 122 are adapted to removably and securely fit within a pair of openings 110 within a branch 106. At least one branch 106 should have at least three openings 110, and preferably more, to allow the bracket 118 to be positioned at multiple positions along the branch 108. This will allow the distance between the brackets 118 of the portable gun and crossbow holder 100 to be varied, as needed. Each bracket has a pair of upright posts 124. Each post 124 is adapted to adjustably secure a strap 128 between the posts 124. The upright posts 124 can be fabricated by bending a piece of steel rod into a U-shape, as shown in FIG. 3. Preferably, the upright posts 124 are provided with stops 126 at their terminal ends. The stops 126 prevent the strap 128 from sliding down the upright posts 124 when the strap 128 is weighted with a gun 102 or a crossbow 104. A stop 126 may be provided by fabricating a horizontally oriented cylindrical flange near the terminal end of a post 124, as shown in FIG. 3. If the strap 128 is provided with multiple openings 130 at one end of the strap 128, the length of the strap 128 between the posts 124 to which it is attached may be adjusted by securing one end of the strap 128 to a post 124 with different openings 130 of the strap 128. Thus, the posts 124 are adapted to adjustably secure a strap 128 between the posts 124.

Each bracket 118 is secured to a branch 108 by an anchor projecting member 122 extending through an opening 110 within the branch 108, as shown in FIG. 3. The preferred anchor 120 is simply a smaller U-shaped bracket, as shown in FIG. 3. The anchor 120 should be welded to the removable bracket 118. The lower projecting members 122 of the anchor 120 are the legs of a U-shaped bracket anchor 120. The lower projecting members 122 of the anchors 120 should have an unequal length. This will more securely attach the bracket 118 to the body 106 and tend to prevent the bracket 118 from becoming inadvertently dislodged from the body 106.

One bracket 118 is inserted into each branch 108. One strap is attached to the pair of upright posts 124 of each bracket 118. One end of the strap 128 should have multiple openings 130 configured such that each opening 130 is attachable to a post 124 of a bracket 118 such that each opening 130 provides a different strap 128 length between the posts 118 to which it is attached.

The brackets 118 form a channel 132. The channel 132 is longitudinally aligned with the body 106 providing a recess within which a gun 102 or a crossbow 104 may be inserted. The straps 128 form a sling 134 within the longitudinally aligned channel 132, as shown in FIG. 4. The sling 134 is adapted to hold a gun 102 or a crossbow 104. The length between the sling 134 components is adjustable by adjusting the length between the removable brackets 118. The depth of the sling 134 is adjustable by adjusting the effective length of the strap 128. The effective length of the strap 128 is determined by the strap opening 130 selected for attachment to the post 124. A longer strap 128 length between the posts 124 results in a lower (i.e. support closer to the body 106) sling 134, while a shorter effective strap 128 length between the posts 124 results in a higher sling 134 position.

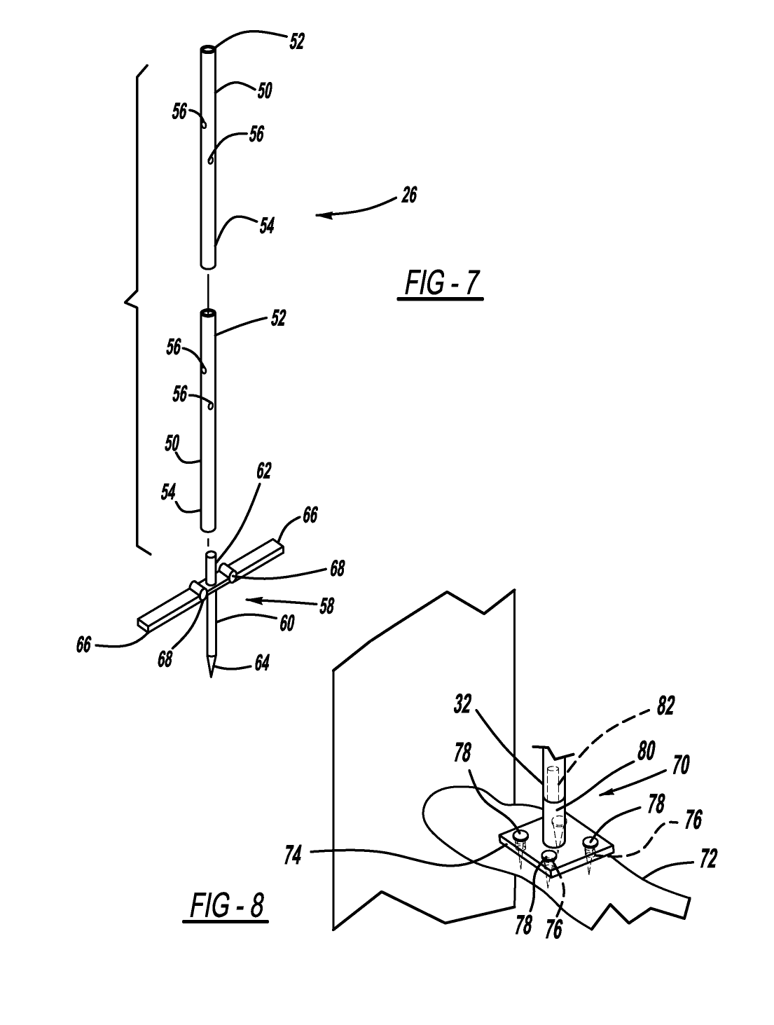

The portable gun and crossbow holder 100 can be attached to a base 58 (see FIG. 6), an extension member 50 (see FIG. 7) or a tree mount 70 (see FIG. 8). It can also be attached to a mount secured to the floor of a tree stand or the floor of a hunting blind. Preferably, the attachment member 114 is fabricated from a malleable metallic pipe. The lower end of the attachment member 114 has a first mating end 32. The first mating end 32 is shaped and sized to mate with a member having a second mating end. The terms first mating end and second mating end are used to distinguish two types of mating end configurations wherein the first mating end is adapted to attach to a second mating end. Preferably, the first mating end 32 of the attachment member 114 is a circular opening at the lower end of the attachment member 114 which is slightly larger than the outside diameter of a second mating end 52, 62 82 of an extension member 50, the stem 60 of a base 58 or the mating member 80 of a tree mount 70, respectively. The depth of the mated fit between the first mating end 32 of the attachment member 114 and the second mating end of the member having a second mating end to which the attachment member 114 is attached is controlled by reducing the inside diameter of the attachment member 114 so that penetration is limited to a desired depth.

FIG. 1 shows the first mating end 32 of the attachment member 114 press fit over the second mating end 52 of an extension member 50. The first mating end 32 of the attachment member 114 may instead be press fit over the second mating end 62 of the stem 60 of a base 58. Alternatively, the first mating end 32 of the attachment member 114 may be press fit over the second mating end 82 of a mating member 80 of a tree mount 70. In all three instances the first mating end 32 of the attachment member 114 is pipe shaped and fit over another pipe shaped member. Other types of first mating ends and matching second mating ends may also be used. For example, the outside portion of the bottom of the attachment member 114 may fit inside of a pipe shaped member having an inside diameter slightly larger than the outside diameter of the end of the attachment member 114. The mating members may be screwed together. The mating members may have mating ends which are keyed to lock with each other.

The described preferred portable gun and crossbow holder 100 may be attached to a ground mounting base 58 or a tree mount 70, as described. The portable gun and crossbow holder 100 may also be equipped with an arrow or bolt quiver, if the portable gun and crossbow holder 100 is to be used to hold a crossbow 104.

The portable gun and crossbow holder 100 may have one or more extension members 50 between it and the base 58. The portable gun and crossbow holder 100 may be attached directly to the second mating end 62 of the stem 60 of a base 58, or it may be attached directly to the second mating end 82 of the mating member 80 of a tree mount 70. Both of these configurations provide a low gun 100 or crossbow 104 holding position. The extension members 50 are used to raise the gun 100 or crossbow 104 holding position by raising the position of the sling 134 of the portable gun and crossbow holder 100. Each extension member 50 has a second mating end 52 at its upper end. The second mating end 52 is shaped and sized to mate with a member having a first mating end 32, 54, as previously described. Each extension member 50 has a first mating end 54 at its lower end. The first mating end 54 is shaped and sized to mate with a member having a second mating end 52, 82, as previously described. The extension members 50 may be fabricated from malleable metallic pipe. Preferably, the mating ends 52, 54 of the extension members 50 consist of inside and outside pipe diameters which fit together, as previously described.

The base 58 is comprised of a stem 60 and a pair of pedals 66. Preferably, the stem 60 is fabricated from a metal rod having a pointed end 64 at its lower end. The pointed end 64 is inserted into the ground during use. The upper end of the stem 60 has a second mating end 62. The second mating end 62 is shaped and sized to mate with a member having a first mating end 32, 54, as previously described. Preferably, the second mating end 62 is fabricated from malleable metallic pipe. The second mating end 62 should be configured so that it may be press fit into the first mating end 32 of the attachment member 114, or the first mating end 54 of an extension member 50. However, other mating combinations may be used, as previously described.

The pedals 66 are hingedly attached to the stem 60, as shown in FIG. 6 and FIG. 7. The pedals 66 fold between an upright position, as shown by the phantom pedals 66 in FIG. 6 and a horizontal position, as shown by the non-phantom pedals 66 in FIG. 6. Because the pedals 66 are physically limited from going below the horizontal plane, they may be used to apply a ground insertion force to the stem 60 by the user stepping on one or both pedals 66. The pedals 66 may be fabricated from steel. Preferably, the pedals 66 are fabricated into rectangular forms, as shown in FIG. 6. A hinge 68 is used to connect each pedal 66 to the stem 60.

Each pedal 66 may be hingedly attached to the stem 60 in the following manner. Two nuts are attached to one of the shorter peripheral edges of the pedal 66. A nut is attached to the stem 60. The nuts are aligned such that a threaded bolt may be inserted through each nut and such that the longitudinal axis of the threaded bolt forms a hinge axis for the pedal 66. The nuts are secured to each other by inserting a threaded bolt through each nut. The threaded bolt is fixed to the two nuts attached to the pedal 66, but allowed to rotate within the nut attached to the stem 60, thereby forming a pedal hingedly attached to the stem 60.

If one or more extension members 50 are used to raise the gun 100 or crossbow 104 holding position, the lower end of one extension member 50 is attached to the upper end of the stem 60. Preferably, the lower end of another extension member 50 is attached to the upper end of the extension member 50 which is attached to the stem 60. When one or more extension members 50 are used, the attachment member 114 of the portable gun and crossbow holder 100 is attached to the second mating end 52 of the uppermost extension member 50. Otherwise, if a base 58 without extension members 50 is used, the lower end of the attachment member 114 of the portable gun and crossbow holder 100 is attached to the second mating end 62 of the stem 60. If a tree mount 70 is used without extension members 50, the lower end of the attachment member 114 of the portable gun and crossbow holder 100 is attached to the second mating end 82 of the mating member 80 of the tree mount 70. Extension members 50 may also be used between a tree mount 70 and a bow cradle 28.

An arrow or bolt quiver may be attached to one or more extension members 50. The quiver permits arrows or bolts to be held in close proximity to a crossbow 104 supported by the portable gun and crossbow holder 100. Preferably, the quiver is releasably attached to at least one extension member 50. This will allow the quiver to be attached and detached quickly and easily. The preferred quiver is comprised of an upper frame, a lower frame and a cloth basket.

The upper frame should be fabricated from malleable metal rod. It should be formed as a rectangle with two mounting prongs. The mounting prongs of the upper frame are adapted to fit within quiver frame mounting holes 56 within an extension member 50. The lower frame should also be fabricated from malleable metal rod. It should also be formed as a rectangle with two mounting prongs. The mounting prongs of the lower frame are adapted to fit within quiver frame mounting holes 56 within an extension member 50. Preferably, the upper frame mounting holes 56 are within an upper extension member 50 and the lower frame mounting holes 56 are within a lower extension member 50. A cloth basket is attached to the lower frame. The upper frame, the lower frame and the cloth basket form a container for holding arrows or bolts. The lower frame and the upper frame should be spaced apart such that the quiver may securely hold a plurality of arrows or bolts.

The portable gun and crossbow holder 100 may be used with a tree mount 70 in a tree. The tree mount 70 mounts to a tree limb 72 and is attachable to the portable gun and crossbow holder 100. A tree mount 70 is comprised of a flange 74 and a mating member 80. The flange 74 is adapted to be seated upon a tree limb 72. The flange 74 has a plurality of fastener openings 76. The fastener openings 76 are adapted to secure the flange 74 upon a tree limb 72 with fasteners 78, such as nails or screws. The fastener openings 76 may consist of a plurality of openings adapted to receive nails or screws, as shown in FIG. 8. Preferably, the flange 74 has four fastener openings 76. The fastener openings 76 may be nail holes or screw holes. The fastener openings 76 may also be slots opening into the external periphery of the flange 74. The size of the fastener openings 76 should be sufficiently large to permit fastener stems to pass through, yet be sufficiently small to prevent fastener heads from passing through.

The components of the support structure for the portable gun and crossbow holder 100 should have approximately the following dimensions and material specifications. However, it must be emphasized that this invention is not limited to these dimensions and materials and other embodiments of the invention may have significantly different dimensions and materials. The preferred inside diameter of the first mating end 32 of the attachment member 114 is 9/16″. ⅝″ outside diameter pipe may be used for the attachment member 114. The second mating ends 52, 62, 82 of the extension member 50, the stem 60 of the base 58 and the mating member 80 of the tree mount 70 should have outside diameters of 17/32 ″. The preferred length of the extension members 50 is 10½″. The preferred penetration depth of second mating ends 52, 62 82 into first mating ends 32, 54 is ⅝″. The preferred distance between the upper frame of the quiver and the lower frame of the quiver is 14 inches.

In order to use the portable gun and crossbow holder 100 in a standing position, the portable gun and crossbow holder 100, one or two extension members 50 and the base 58 are assembled together, as shown in FIG. 1 or FIG. 7. Optionally, a quiver may be attached to the extension members 50. The pedals 66 of the base are unfolded and foot pressure is used to insert the stem 60 into the ground. A first extension member 50 is attached to the second mating end 62 of the stem 60. In a preferred embodiment the second mating end 62 of the stem 60 is inserted into the first mating end 54 of the first extension member 50 and held together by a press fit. Similarly, the second extension member 50 is attached to the first extension member 50. In a preferred embodiment, the second mating end of the first extension member 50 is inserted into the first mating end 54 of the second extension member 50 and held together by a press fit. The portable gun and crossbow holder 100 is attached to the second extension member 50. In a preferred embodiment, the second mating end of the second extension member 50 is inserted into the first mating end 32 of the attachment member 114 of the portable gun and crossbow holder 100 and held together by a press fit.

In order to attach the portable gun and crossbow holder 100 to one of the described support structures, the branches 108 of the body 106 are first unfolded. The mating end 32 of the attachment member 114 of the body 106 is attached to a second mating end 52, 62, 82 of an extension member 50, a base 58 or a tree mount 70. The bracket anchors 120 of the brackets 118 are inserted into openings 110 of the branches 108. The brackets 118 are positioned along the body 106 such that the desired sling 134 length is obtained. The straps 128 are secured to their respective bracket posts 124. The sling 134 depth is adjusted to a desirable depth by selecting appropriate strap openings 130 for attachment to the upright posts 124.

A hunter may assemble the portable gun and crossbow holder 100 and insert it into the ground of a hunting field. After a gun 100 or crossbow 104 is placed within the portable gun and crossbow holder 100, the hunter may easily stand behind the supported gun 100 or crossbow 104 and await the arrival of a hunted animal. Once the hunted animal arrives the hunter may grasp the gun 100 or crossbow 104 with very little physical movement and prepare to shoot. The ability to grasp the gun 100 or crossbow 104 and shoot with very little physical movement by the hunter provides a hunting advantage because the hunted animal is much less likely to notice the hunter and quickly flee.

If the hunter desires to hunt from a lower position, the portable gun and crossbow holder 100 may be used with only one extension member 50. If the hunter desires to ground hunt from a seated position, the portable gun and crossbow holder 100 may be attached directly to the base 58. If the hunter desires to hunt from a tree, a tree mount 70 is attached to a tree limb 72 by nailing or screwing the tree mount flange 74 to the tree limb 72. The portable gun and crossbow holder 100 is then attached to the second mating end 82 of the mating member 80 of the flange 74. The portable gun and crossbow holder 100 position may be raised by using one or more extension members 50.

The portable gun and crossbow holder 100 may also be used in a target shooting setting. There, a target shooter intends to shoot at a target, rather than at hunted animals. The same procedure described above is used to configure the portable gun and crossbow holder 100 to support the target shooter's gun 102 or crossbow 104 in a low, intermediate or high position.

After the hunter is done hunting or the target shooter is done target shooting, the portable gun and crossbow holder 100 and support components may be quickly and easily disassembled. The portable gun and crossbow holder 100 is removed from the extension member 50, the base 58 or the tree mount 72 to which it is attached by pulling the components apart. Any extension members 50 used are separated from the components to which they are attached by pulling them apart. The base 58 is removed from the ground by pulling it out. The pedals 66 of the base 58 are folded such that they are substantially parallel to the stem 60. If a tree mount 70 is used, it may be left in the tree for later use, or it may be removed. The removable brackets 118 are removed from the body 106 of the portable gun and crossbow holder 100. The branches 108 of the body 106 are folded together. The disassembled components should be stored in a small pouch. The pouch may be attached to the user's belt. In this way the components of the portable gun and crossbow holder 100 and support structure may be easily carried by a user.

The portable gun and crossbow holder 100 has many advantages. It can be mounted on the ground, a tree limb, the floor of a treestand or the floor of a hunting blind. It is usable in the field. Most, or all, other gun and crossbow holders are not usable in the field. It holds and keeps a gun 100 or crossbow 104 elevated above the ground or a tree limb 72 upon which it is mounted. Its height is adjustable so that a user can use the portable gun and crossbow holder 100 while sitting, standing or squatting. It is easy to store. It is lightweight and takes up minimal space. It can be quickly assembled. It may also be equipped with a quiver for holding arrows or bolts.

The portable gun and crossbow holder 100 has additional advantages. It will function with virtually all commonly used target and hunting guns and crossbows currently on the market. The gun 100 or crossbow 104 removal and insertion process is silent. The gun 100 or crossbow 104 is unlikely to be scratched or damaged by the portable gun and crossbow holder 100.

Although the invention has been shown and described with reference to certain preferred embodiments, those skilled in the art undoubtedly will find alternative embodiments obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. A portable gun and crossbow holder comprising:
(a) two hingedly connected branches which form a body having a folded configuration and an unfolded configuration, wherein the folded configuration has a shorter longitudinal length than the unfolded configuration, each said branch having one or more openings for receiving a removable bracket anchor;
(b) an attachment member downwardly projecting from a central section of said body, said attachment member having a first mating end at its distal end for attachment to a second mating end;
(c) a pair of removable brackets, each said bracket having an anchor comprising at least one lower bracket projecting member adapted to removably and securely fit within an opening of a branch, each said bracket having a pair of upright posts, each said post being adapted to secure a strap between the posts, each said bracket being secured to a branch by a bracket projecting member extending through an opening within the branch; and
(d) one strap attached to each pair of upright posts;
(e) wherein the brackets form a channel longitudinally aligned with the body for receiving a gun or a crossbow; and
(f) wherein the straps form a sling within said longitudinally aligned channel to support a gun or a crossbow within the channel.

2. A portable gun and crossbow holder comprising:
(a) two hingedly connected branches which form a body having a folded configuration and an unfolded configuration, wherein the folded configuration has a shorter longitudinal length than the unfolded configuration, each said branch having one or more openings for receiving a removable bracket anchor, at least one of said branches having a plurality of openings for receiving a removable bracket anchor at multiple positions along said branch;
(b) an attachment member downwardly projecting from a central section of said body, said attachment member having a first mating end at its distal end for attachment to a second mating end;
(c) a pair of removable brackets, each said bracket having an anchor comprising at least one lower bracket projecting member adapted to removably and securely fit within an opening of a branch, at least one of said removable brackets having a pair of lower projecting members adapted to removably and securely fit within a pair of openings within a branch at multiple positions along said branch, each said bracket having a pair of upright posts, each said post being adapted to adjustably secure a strap between the posts, each said bracket being secured to a branch by a bracket projecting member extending through an opening within the branch; and
(d) one strap attached to each pair of upright posts, one end of each said strap having multiple openings configured such that each opening is attachable to a post of a bracket such that each opening provides a different strap length between the posts to which it is attached;
(e) wherein the brackets form a channel longitudinally aligned with the body for receiving a gun or a crossbow; and
(f) wherein the straps form a sling within said longitudinally aligned channel to support a gun or a crossbow within the channel.

3. The portable gun and crossbow holder of claim 2, wherein at least one bracket has a pair of lower projecting members of unequal length for more securely attaching that bracket to the body.

4. The portable gun and crossbow holder of claim 2, wherein the first mating end of the attachment member is releasably attached to a base.

5. The portable gun and crossbow holder of claim 4, wherein the base is adapted to be inserted into the ground and has foldable pedals adapted to apply a ground insertion force to the base.

6. The portable gun and crossbow holder of claim 4, wherein the base is lengthened by at least one extension member.

7. The portable gun and crossbow holder of claim 4, wherein the base is a tree mount.
